(19) United States
(12) Patent Application Publication
(10) Pub. No.: US 2026/0264124 A1
(43) Pub. Date: Sep. 10, 2026

(54) UNDIFFERENTIATED WASTE SEPARATION DEVICE

(71) Applicant: FLUITECO SRL, Chiesanuova (SM)

(72) Inventors: Irish DE BIAGI, Chiesanuova (SM); Roberto GATTO, Chiesanuova (SM)

(73) Assignee: FLUITECO SRL, Chiesanuova (SM)

(21) Appl. No.: 18/721,313

(22) PCT Filed: May 19, 2023
(86) PCT No.: PCT/IB2023/055163

§ 371 Date: Jun. 18, 2024

(30) Foreign Application Priority Data
May 20, 2022 (SM) SM-P-202200216

(51) Int. Cl. B09B 3/35; B04C 3/06

(52) U.S. Cl. CPC B09B 3/35; B04C 3/06

(57) ABSTRACT

An undifferentiated waste separation device includes a centrifugal separation chamber extending mainly in a direction of crossing of the waste V and internally divided into two sub-chambers nested together around a centrifuge axis central parallel to the crossing direction V. The sub-chambers are separated by a filter. The radially innermost sub-chamber contains a vane shaft rotating around the centrifugal axis and the shaft includes a several centrifugal vanes. In the internal sub-chamber, there is an entrance area for the waste to be separated. In the internal sub-chamber, there is a first expulsion area of the waste fraction retained by the filter in the internal sub-chamber. In the external sub-chamber, there is a second outlet area of the waste fraction passed through the filter. The device injects forced air into the internal sub-chamber.

The present invention relates to the recycling sector, in particular it relates to an undifferentiated waste separation plant.

By undifferentiated waste we mean waste that contains both food waste or in general quickly biodegradable, hereinafter referred to as “wet fraction”, and packaging or other materials that are poorly or non-biodegradable, generally paper, plastic, wood and metal, hereinafter referred to as “dry fraction”.

In the following, separation is understood to mean the separation of the wet fraction from the dry fraction.

### STATE OF THE ART

In the waste sector, undifferentiated collection is still widespread, which at the same time constitutes an ecological management problem and a loss of useful resources.

Even in the case of separate collection, separation is often done with little attention by users, or even deliberately avoided, so that the biodegradable material delivered is contaminated by packaging or other foreign materials.

Likewise, the need to dispose of expired products that are no longer salable and that need to separate packaging from food is known.

All these wastes, for the purposes of the present invention, are therefore considered undifferentiated waste.

To solve the general problem of separating the biodegradable wet fraction, a method of disposal and recovery has become widespread which involves shredding the waste and separating it by centrifugation.

The known systems for this purpose are numerous and generally provide for a separation device with a vertical axis, inside which blade carrying shaft rotates inside a cylindrical filter. The blades are arranged to form a discontinuous helix, so that they have the triple purpose of chopping the waste, pushing it radially outwards and pushing it vertically upwards. In this way the wet fraction is separated from the filter thanks to the radial thrust to the impeller, while the dry fraction retained by the filter is expelled from above for vertical lifting.

An example of an apparatus of this type is known from patent EP2006034B1, the particularity of which is to dilute the waste during centrifugation by introducing water into the separation device.

On the one hand, this improves the separation capacity of the wet fraction and its passage through the filter, but also creates a number of drawbacks, some of which are listed below:
a considerable amount of water is needed, which is actually wasted;
the separated dry fraction comes out very wet and often requires a drying step in special cyclones;
the undifferentiated waste to be separated is introduced into the device by an auger, but the amount of water and waste moved in the centrifuge generates a counterthrust that opposes its entry;
the machine is easily clogged with plastic bags that twist around the blade shaft, so frequent stops and disassembly are required;

The object of the present invention is to completely or partially overcome the problems of the known art.

A preferred object of the present invention is to increase the efficiency of the machine, for example because it achieves at least one of the following advantages:
reduces or eliminates the need to add dilution water;
increases the production capacity as it reduces or cancels the counter-thrusts that hinder the delivery of waste to the separation device;
allows to obtain a relatively dry separated dry fraction;
reduces the frequency of obstruction of the separation device.

### General Introduction

According to a first general aspect thereof the present invention relates to a undifferentiated waste separation device comprising a centrifugal separation chamber (40) extending mainly in a direction of crossing of the waste V and internally divided into two sub-chambers (50, 52) nested together around a centrifuge axis central (X3) parallel to the crossing direction V, where:
the sub-chambers (50, 52) are separated by a filter (60)
the radially innermost sub-chamber (52) contains a vane shaft (55) rotating around said centrifugal axis (X3),
the shaft (55) comprises a plurality of centrifugal vanes (56);
in the internal sub-chamber (52) there is an entrance area (42) for the waste to be separated;
in the internal sub-chamber (52) there is a first expulsion area (53) of the waste fraction retained by the filter (60) in the internal sub-chamber (52)
in the external sub-chamber (50) there is a second outlet area (46) of the waste fraction passed through the filter (60);
characterized in that the device comprises means for injecting forced air (80, 68) into the internal sub-chamber (52).

Advantageously, the lighter parts, such as plastic packaging, in particular bags, are helped to pass through the separation chamber, reducing or avoiding jamming it. This reduces the number of stops and the need for an operator to intervene.

Furthermore, the need for dilution water is considerably reduced or eliminated. For example, if it is used, it can be placed in the waste before entering the separation chamber.

According to some preferred embodiments the injection means comprise at least one injection area (68) located between the waste inlet area (42) and the first ejection area (53).

For example, in the case of vertical crossing direction, the inlet zone (68) is placed vertically above (H2) the waste entry zone (42) and vertically below the first ejection zone (53).

Preferably the means for injecting forced air comprise means for recirculating forced air (53, 67, 69).

In such a case preferably:
a portion of the shaft (55) extends into said expulsion area (53), where it comprises at least one radial expulsion paddle (58), facing in a radial direction to at least one forced air drawing opening (65),
duct means (67, 69) configured to convey the forced air from the forced air drawing opening (65) to the injection area (68).

According to an architecture that particularly reduces the number of components required and thus simplifies construction said at least one expulsion paddle (58) faces radially both to at least one outlet opening (44) of the waste retained by the filter (60), and to the drawing opening (65), where the latter is shielded by a filter (66) to substantially allow the exit of forced air only.

According to a second aspect thereof the invention relates a undifferentiated waste separation plant, characterized in that it comprises a separation device (10) according to any one of the preceding claims, a loading portion (5) downstream of the loading device, and a shredder (15) operatively interposed between them to shred the waste coming from the loading portion and feed the inlet area (42) of the separation device (10) with the shredded waste.

According to some preferred embodiment the plant comprises thrust increase means (30) configured to generate an increase in thrust of the crushed waste coming out of the shredder (15).

Preferably the thrust increase means (30) comprise means for introducing forced air (32) into the shredder (15).

In this case, the means for introducing forced air (32) into the shredder (15) preferably take forced air from the separation device (10).

According to an architecture which particularly reduces the number of components required and therefore simplifies the construction, the means for introducing forced air (32) into the shredder (15) comprise at least one forced air bypass from the means for introducing forced air (80, 68) in the internal sub-chamber (52).

### DETAILED DESCRIPTION

Further characteristics and advantages of the present invention will become clearer from the following detailed description of its preferred embodiments, made with reference to the attached drawings and given by way of non-limiting example. In such drawings:

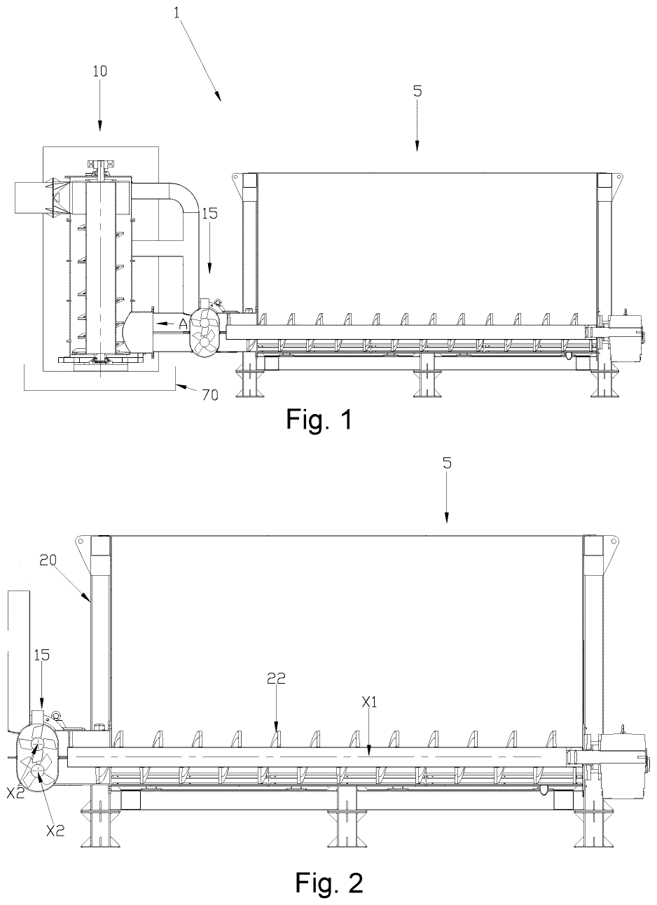

FIG. 1 schematically shows a sectional view of a separation plant according to the present invention;

FIG. 2 schematically shows and in section the loading portion of the system of FIG. 1;

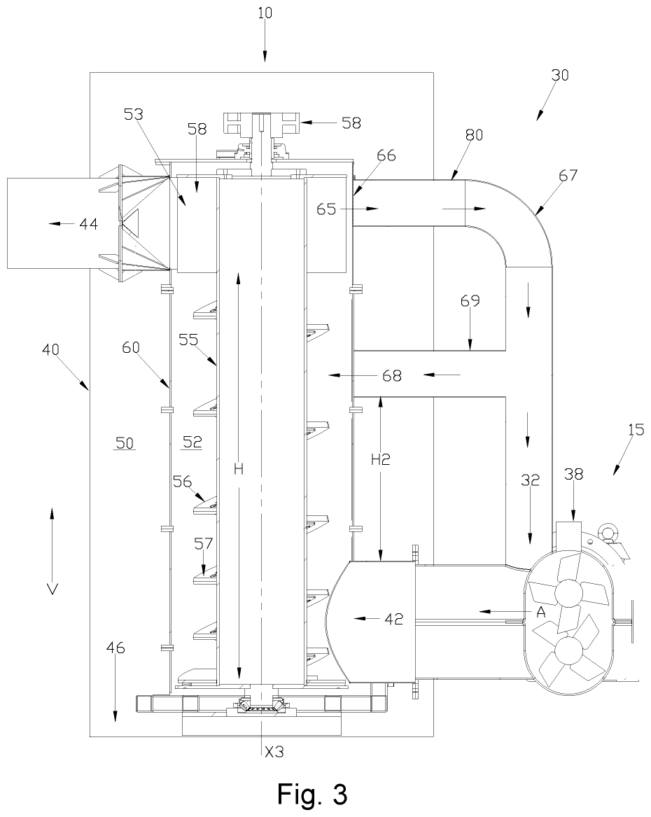

FIG. 3 schematically shows in section the separation device of the plant of FIG. 1 and its connection with the shredder;

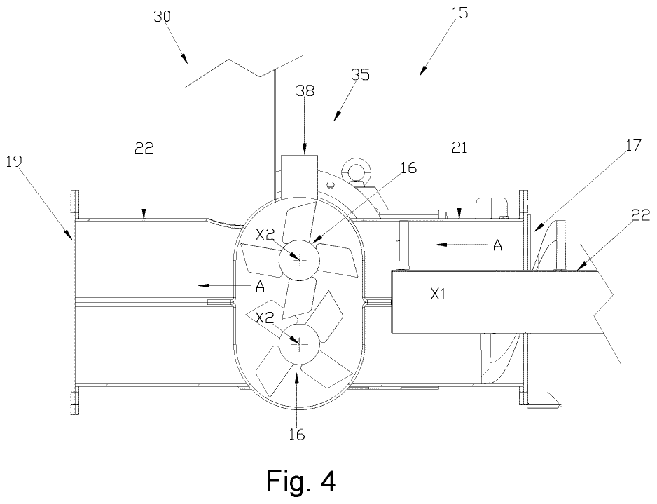

FIG. 4 shows schematically and in section the shredder of the plant of FIG. 1.

With reference to FIG. 1, a plant for the separation of undifferentiated waste according to the present invention is illustrated, indicated as a whole with the reference number 1.

The separation plant 1 comprises a loading portion 5, a separation device 10 and a shredder 15 operatively interposed between them.

The loading portion 5 comprises a hopper 20, open at the upper end for the introduction of undifferentiated waste, on the bottom of which there is a screw 22, with a horizontal X1 axis, which conveys the undifferentiated ebbs towards the shredder 15.

The shredder 15 comprises at least one blade-carrying shaft 16 rotating around an axis X2, preferably orthogonal with respect to the flow through which the waste is indicated by the arrow “A”, where said flow is preferably parallel to the axis of rotation X1 of the screw 22 of the portion load 5.

The shredder 15 is generally configured to take the undifferentiated waste carried by the auger 22, chop it to generate a chopped waste, and generate a first push of the chopped waste towards the separation device 10.

In the illustrated example, two counter-rotating blade holder shafts 16 are represented. The respective rotations are in a direction such as to generate the rejection crossing A between said shafts.

The shredder 15 comprises an inlet opening 17, through which it is connected to the loading portion 5, and an outlet portion 19, through which it is connected to the separation device 10.

It is not excluded that the shredder comprises a conveying duct (21, 22) between the at least one blade-holding shaft 16 and the inlet opening 17 and/or between the at least one blade-holding shaft 16 and the outlet opening 19.

The plant 1 further comprises thrust increase means 30 configured to generate an increase in thrust of the crushed waste coming out of the shredder 15.

The thrust increase means 30 comprise means for introducing a pressurized fluid 32 into the shredder 15. The fluid is preferably air.

Preferably the plant also comprises waste dilution means 35 placed upstream of the separation device. Preferably they are distinct from the thrust increase means, for example they comprise a port 38 for feeding dilution water into the shredder 15.

The separation device 5 is generally of the centrifugal type, ie it pushes the material radially against a filter. According to a preferred example illustrated, it has a predominantly vertical direction of development, in particular it comprises a separation chamber 40 with at least one lower inlet 42 for the shredded waste, at least a first outlet 44 for the dry fraction separated from the waste, and at least one second exit 46 for the wet fraction separated from the waste.

The separation chamber 40 extends mainly in a direction through which the waste passes from the inlet 42 to the first outlet 44, which preferably coincides with the vertical direction V, and is internally divided into two sub-chambers 50 and 52 which are at in turn extended and parallel to each other in said crossing direction V, where the sub-chambers are nested together.

The sub-chambers 50 and 52 are separated by a filter 60 comprising a plurality of openings, for example holes, adapted to substantially allow the passage of the wet fraction and to retain the dry fraction of the crushed waste.

The filter 60, for example, is a drum, for example cylindrical, comprising a plurality of holes for its entire height H.

The innermost sub-chamber 52 contains a vane shaft 55 with a vertical axis of rotation X3, having the function of centrifuging the crushed waste. The X3 axis is said for this centrifuge axis. The shaft 55 comprises, starting from the lower part and preferably at least for most of the height, preferably at least for the whole height H of the filter 60, a plurality of centrifuge blades 56.

Preferably the pallets 56 comprise an upper surface 57 inclined both with respect to a vertical plane and with respect to a horizontal plane, so as to favor the upward thrust of the waste.

At the distal end from the inlet 42 of the internal sub-chamber 52, where said distal end preferably is at the top, there is an expulsion area 53 of the dry fraction where the outlet opening 44 is located, preferably facing radially with respect to the axis of centrifuge X3.

An end of the shaft 55 extends into said ejection zone 53, where it preferably comprises at least one radial ejection vane 58, having an operating surface which extends substantially in a radial plane, more preferably a plurality of them. The at least one blade 53 for example is a flange with a main development in said radial plane.

Said radial expulsion vanes 58 face in a radial direction the outlet opening 44 from the internal sub-chamber 52.

Preferably, the expulsion area 53 has a forced air intake, represented in the example by at least a second radial outlet opening 65, shielded by a filter 66 to substantially allow the exit of forced air only, which is then conveyed to the shredder 15 by means of the duct 67. The opening 65 and the duct 67 are an example of means 80 for drawing forced air forming part of the means for increasing the thrust 30.

In this way there is a recovery and reuse of forced air, although solutions are not excluded in which the thrust increasing means 30 take the forced air from a source other than the separation device.

In addition or as an alternative to the conveyance to the shredder 15, the forced air of the outlet 65 can be conveyed back into the internal sub-chamber 52, preferably at a predetermined distance H2 downstream of the inlet 42 in the crossing direction V. In the example in figure, where the crossing direction V and the centrifuge axis X3 are vertical, the forced air outlet 65 is above the shredded waste inlet 42.

For this purpose, the internal sub-chamber 52 comprises for example a further forced air inlet 68 connected to the outlet 65 by means of conveying means 69. The example in the figure shows an example in which they are represented by at least one opening at height H2 fed by a branch duct 69 from the duct 67 of the thrust increase means 30.

In general, the opening 68 defines a preferred zone of forced air intake between the inlet zone defined by the inlet opening 42 and the expulsion zone 53.

Conceptually, the openings 65 and 68 and the relative connecting ducts are an example of means for injecting forced air into the separation device 10 of the recirculating type, where the withdrawal means 80 are in common with the thrust increase means 30.

Solutions are not excluded in which there is a conveyance of forced air into the internal sub-chamber 52 at distance H2 from different sources, such as forced air generators external to the chamber 40.

The vane shaft 55 is rotated by motor means 58, preferably placed at the top of the separation device in such a way as to leave the area below it free to accommodate a collection tank for the wet fraction 70.

The outlet opening 46 is preferably located in the lower part of the external sub-chamber 50.

In general, it is observed that the orientation of the inlets and outlets from the chamber 40 is not binding, for example the outlet of the dry fraction and the forced air may be different from radial, being for example axial. In the latter case there is no need for the radial vanes 58 and the centrifuge vanes 56 can also be present in the ejection zone 53.

In general, it is not excluded that the orientation of the direction of crossing of the separation device, and therefore of the centrifugal axis X3 of the vane shaft 55, is different from vertical, for example horizontal.

In use, the undifferentiated waste is inserted into the hopper 20 and delivered to the shredder 15 by the screw 22.

The shredder 15 shreds the waste and pushes it in the direction of advance A towards the separation device.

The thrust increase means 30 increase the thrust of the crushed waste, for example by blowing forced air into the shredder 15, or in general by introducing a fluid under pressure.

Thanks to the increased thrust, the waste stream easily enters the separation device 10, overcoming the opposition generated by the rotation of the vane shaft 55.

Furthermore, it has been observed that the increase in thrust, especially with forced air, favors the advancement of the packages, which therefore have a preferential exit from the shredder 15 earlier than the wet fraction, so that they enter the separation chamber 40 without obstructing the vane shaft 55 and are easily ejected.

This reduces the need for shutdown and disassembly for unblocking operations.

Furthermore, the need to add water to fluidize the wet fraction is reduced or absent with respect to the known art, and in any case it is done before entering the separation device 5, in particular the shredder.

All these characteristics also have the advantage of expelling a drier dry fraction from the separation device, especially when the air expelled together with this fraction is recovered and blown back into chamber 40, where it also helps to lift the dry fraction itself.

### General Interpretation of Terms

In understanding the scope of the present invention, the term “comprising” and its derivatives, as used herein, are intended as open-ended terms that specify the presence of the claimed characteristics, elements, components, groups, integers and/or phases, but they do not exclude the presence of other undeclared characteristics, elements, components, groups, integers and/or phases. The above also applies to words that have similar meanings such as the terms “including”, “having” and their derivatives. Furthermore, the terms “part”, “section”, “portion”, “member” or “element” when used in the singular can have the dual meaning of a single part or of a plurality of parts. As used herein to describe the form(s) above, the following directional terms “forward”, “backward”, “above”, “down”, “vertical”, “horizontal”, “below” and “transverse” as well as any other similar directional term refers to the embodiment described in operative position. Finally, degree terms such as “substantially”, “about” and “approximately” as used herein mean a reasonable amount of deviation of the modified term such that the final result is not significantly changed.

While only selected embodiments have been chosen to illustrate the present invention, it will be apparent to those skilled in the art from this disclosure that various modifications and variations can be made without departing from the scope of the invention as defined in the appended claims. For example, the size, shape, position or orientation of the various components can be changed as needed and/or desired. The components shown directly connected or in contact with each other can have intermediate structures arranged between them. The functions of one element can be performed by two and vice versa. The structures and functions of one embodiment may be adopted in another embodiment. It is not necessary for all the advantages to be present in a particular embodiment at the same time. Any feature that is original compared to the prior art, alone or in combination with other features, should also be considered a separate description of further inventions by the applicant, including the structural and/or functional concepts embodied by those features. Therefore, the foregoing descriptions of the embodiments according to the present invention are provided for illustrative purposes only and not for the purpose of limiting the invention as defined by the appended claims and their equivalents.

1. Undifferentiated waste separation device comprising a centrifugal separation chamber extending mainly in a direction of crossing of waste V and internally divided into two sub-chambers nested together around a centrifuge axis central parallel to the crossing direction V, wherein:
the sub-chambers are separated by a filter;
a radially internal sub-chamber of the sub-chambers contains a vane shaft rotating around said centrifugal axis;
the shaft comprises a plurality of centrifugal vanes;
in the internal sub-chamber, there is an entrance area for the waste to be separated;
in the internal sub-chamber, there is a first expulsion area of the waste fraction retained by the filter in the internal sub-chamber;
in an external sub-chamber of the sub-chambers, there is a second outlet area of the waste fraction passed through the filter;
wherein the device comprises means for injecting forced air into the internal subchamber.

2. Separation device according to claim 1 where, with reference to said crossing direction, the injection means comprise at least one injection area located between the waste inlet area and the first ejection area

3. Separation device according to claim 1, wherein the means for injecting forced air comprise means for recirculating forced air.

4. Separation device according to claim 3, wherein:
a portion of the shaft extends into said expulsion area, where it comprises at least one radial expulsion paddle, facing in a radial direction to at least one forced air drawing opening,
duct means configured to convey the forced air from the forced air drawing opening to the injection area.

5. Separation device according to claim 4, wherein said at least one expulsion paddle faces radially both to at least one outlet opening of the waste retained by the filter, and to the drawing opening, where the latter is shielded by a filter to substantially allow the exit of forced air only.

6. Undifferentiated waste separation plant, further comprising a separation device according to claim 1, a loading portion downstream of the loading device, and a shredder operatively interposed between them to shred the waste coming from the loading portion and feed the inlet area of the separation device with the shredded waste.

7. Plant according to claim 6, further comprising a means for boosting the thrust configured to generate a thrust boost of the shredded waste leaving the shredder.

8. Plant according to claim 7, wherein the thrust boost means (30) comprise means for introducing forced air into the shredder.

9. Plant according to claim 8, wherein the means for introducing forced air into the shredder draws forced air from the separation device.

10. Plant according to claim 9, wherein the means for introducing forced air into the shredder comprise at least one drawing of forced air from the means for introducing forced air into the internal sub-chamber.
